(19) United States
(12) Patent Application Publication
(10) Pub. No.: US 2011/0167171 A1
(43) Pub. Date: Jul. 7, 2011

(54) SYSTEM AND METHOD FOR NETWORK CONTENT DELIVERY

(76) Inventor: Adam Dunstan, Watertown, MA (US)

(21) Appl. No.: 12/974,589

(22) Filed: Dec. 21, 2010

Related U.S. Application Data
(60) Provisional application No. 61/290,388, filed on Dec. 28, 2009.

(51) Int. Cl. G06F 15/173

(52) U.S. Cl. 709/238

(57) ABSTRACT

A method and apparatus for distribution of digital content by controlling multicast distribution between caches using XMPP. A content cache manager constructs a database of distributed caches and content sources. Each content source is allocated a multicast address. content sources and multicast addresses are distributed to caches. A cache with a client requesting a matching content source joins the multicast group of the content source to receive content.

### CROSS REFERENCE TO RELATED APPLICATION

The present application claims priority to U.S. Provisional Patent Application No. 61/290,388 filed on Dec. 28, 2009 which is incorporated herein by reference in its entirety.

### FIELD

The present invention relates to information networks generally and more particularly to a system and methods for network content delivery.

### BACKGROUND

First invented in 1998, the Extensible Messaging and Presence Protocol (XMPP) is a real-time communication technology based on core protocols and developed by the XMPP open source community. XMPP is used for various applications such as instant messaging, presence, multi-party chat, voice and video calls, collaboration, lightweight middleware, content syndication, and generalized routing of XML data. The XMPP Standards Foundation is an open standards development organization that defines open protocols for presence, instant messaging, and real-time communication. Such applications are based on a decentralized infrastructure for internet communication.

### SUMMARY OF THE INVENTION

A system for network content delivery comprises a receiving device, a plurality of content caches, a content source, a content cache manager, and a receiving device. A content source distributes multicast content to the content caches, which in turn provide multicast content to the receiving device as determined by the content cache manager. The content cache manager communicates using XMPP with the content source and with the plurality of content caches.

### BRIEF DESCRIPTION OF THE DRAWINGS

FIG. 1 shows a system diagram for network content delivery.

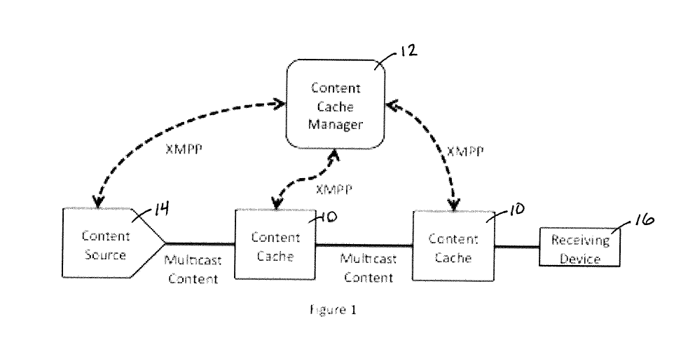

### DETAILED DESCRIPTION

The invention provides a method and apparatus for optimizing the distribution of digital content by controlling multicast distribution between caches 10 using XMPP. Where the same information is required by a large group of users, this invention optimizes distribution by delivering the minimum number copies of digital content.

A directory or database of content and multicast address mappings is established in a content cache manager 12. A uniform resource locator identifies content and each content mapping includes a multicast address.

Content sources 14 register presence with the content cache manager 12 using XMPP. Each content cache 10 is loaded with the content database from the content cache manager 12. There can be multiple content caches 10 between the destination receiver 16 and the content source 14.

The receiving device 16 forwards uniform resource (URL) locator requests that are intercepted by the content cache 10. Should the URL request match a content mapping entry in the XMPP server, the content cache 10 joins the provided multicast group. The content cache 10 stores received information for use by other receiving devices 16.

Each content cache reports an operating status to the content cache manager using XMPP.

What is claimed is:

1. A system for network content delivery comprising:
a receiving device;
a plurality of content caches providing multicast content to said receiving device;
a content source, said content source providing multicast content to at least one of said plurality of content caches
a content cache manager in XMPP communication with said content source and with said plurality of content caches.

2. A method of network content delivery comprising:
establishing a database directory in a content cache manager;
registering presence with the content cache manager using XMPP;
providing to a content source a multicast address for each content origination;
distributing multicast content from the content source to a plurality of content caches;
storing multicast content on at least one of said plurality of content caches;
providing multicast content from at least one of said plurality of content caches to a receiving device;
communicating by a content cache manager, using XMPP, with said content source and with said plurality of content caches.
forwarding URL locator requests; and
reporting an operating status from each plurality of content caches to the content cache manager using XMPP.
